(19) United States
(12) Patent Application Publication
(10) Pub. No.: US 2006/0163087 A1
(43) Pub. Date: Jul. 27, 2006

(54) Reaction conditions sensor

(75) Inventors: Brian Phillip Allen, Essex (GB); Richard Gilbert, Essex (GB); Xioa Feng Zhou, Essex (GB)

Correspondence Address: HELLER EHRMAN WHITE & MCAULIFFE LLP, 1717 RHODE ISLAND AVE, NW, WASHINGTON, DC, 20036-3001, US

(73) Assignee: E2V Technologies (UK) Limited, Essex (GB)

(21) Appl. No.: 10/567,016

(22) PCT Filed: Jul. 19, 2004
(86) PCT No.: PCT/GB04/03143

§ 371 Date: Feb. 3, 2006

(30) Foreign Application Priority Data
Aug. 5, 2003 (GB) 0318356.3

(51) Int. Cl. G01N 27/26

(52) U.S. Cl. 205/775; 204/401

(57) ABSTRACT

A method and apparatus for detecting adverse conditions during the analysis of chemical and biological processes are disclosed. In one embodiment, the reaction conditions in a microelectrochemical reaction chamber are monitored. The reaction chamber comprises electrodes arranged to pass an electric current through reaction mixture located within the reaction chamber, thereby inducing an electrochemical reaction. A detection circuit is provided to detect and measure the electric current flowing between the electrodes. The detection circuit is arranged to generate a signal indicating whether the measured current lies inside or outside a predetermined range of values. If the measured current lies outside the expected range of values, then the reaction conditions are adverse. A single pair of electrodes may perform a dual function of both inducing the electrochemical reaction and allowing the current flowing through the mixture to be measured. In another embodiment, electrodes are used to monitor the conditions in a chamber for detecting the presence of analytes using the combined techniques of surface enhanced Raman scattering and surface plasmon resonance.

### FIELD OF THE INVENTION

This invention relates to a method and apparatus for detecting adverse conditions during the analysis of chemical and biological processes including microelectrochemical reactions, other reactions and the detection of analytes.

### BACKGROUND OF THE INVENTION

A particular area of interest in the pharmaceutical industry is the prediction of how drugs are metabolised in the body. For example, one particular parameter of interest is the maximal rate of reaction between a compound and a metabolic enzyme. During a typical metabolisation process, an oxidative drug-metabolising enzyme (DME) acts to add a hydroxyl moiety to foreign molecules, thus facilitating their metabolic degradation. The reactions catalysed by enzymes such as DMEs are driven by the transfer of electrons. In particular, an important part of the reaction process is that electrons are supplied to the catalytic site within the enzyme so that the enzyme may react with the compound. Reactions involving the transfer of electrons from one species to another are known as oxidation-reduction (redox) reactions. Usually, the electrons which drive metabolic reactions are supplied in vivo by redox partners with the aid of appropriate oxidoreductase enzymes. However, it is known that redox reactions may also be driven artificially by supplying electrons directly using electrodes in an electrochemical reaction chamber. It is in this way that metabolic processes may be studied.

Microelectrochemical reaction chambers are well known in the art. In a typical chamber, a mixture of enzyme, substrate, and mediator is electrochemically reacted by passing an electric current through the mixture, the electric current being provided by a pair of electrodes. The resulting reaction may then be analysed by any suitable means. It is important that the correct conditions are present within the reaction chamber otherwise the properties of any reactions that occur may be affected. In such a case, the results of any analysis of a reaction may be erroneous. One way in which the reaction conditions may be adverse is if the concentrations of reagents in a reaction mixture are altered. Another way in which the reaction conditions may be affected is by the presence of bubbles within the reaction chamber.

It is often desired to analyse other chemical and biological processes other than microelectrochemical reactions such as other types of reaction or the detection of analytes. In these cases, it is also important during analysis that the conditions within the apparatus used are not adverse otherwise spurious results may be obtained.

We have appreciated the importance of detecting adverse conditions during the analysis of chemical and biological processes so that erroneous analysis may be rejected. We have further appreciated that a means to detect adverse conditions may be advantageously provided by existing components of prior apparatus.

### SUMMARY OF THE INVENTION

The invention is defined in the independent claims, to which reference may now be directed. Advantageous features are set out in the dependant claims.

A first embodiment of the invention provides a method and apparatus for detecting that conditions in a microelectrochemical reaction chamber are adverse. In use, a voltage is applied by electrodes across a region of reaction mixture located within the reaction chamber. If the applied voltage is large enough, then current flows between the electrodes, through the mixture, and an electrochemical reaction is induced.

At least two electrodes are provided to detect and measure the electric current. When the reaction conditions are normal, the steady state current flowing between the electrodes lies within a predictable range of values. A steady state current which lies outside the expected range provides an indication that reaction condition within the apparatus are adverse. The magnitude of the steady state current depends upon factors such as the electrode dimensions, the concentration of reagents in the reaction mixture, and on the voltage applied across the electrodes. The electrode current may also be affected by the presence of bubbles within the apparatus.

A detection circuit is provided to compare the measured current with the expected current range, and to generate a signal indicating whether reaction conditions are normal, or adverse. In one embodiment, a single pair of electrodes performs a dual function of both inducing the electrochemical reaction and allowing the current flowing through the mixture to be measured.

In a second embodiment, the size of current flowing between electrodes in a chamber for detecting the presence of analytes using optical sensing is measured to determine whether conditions in the chamber are adverse.

### BRIEF DESCRIPTION OF THE FIGURES

FIG. 1 is a schematic diagram of a microfluidic electrochemical reaction apparatus embodying the invention;

FIG. 2 is a schematic diagram of the detection circuit shown in FIG. 1; and

FIG. 3 is a graph showing the time variation of current measured by reaction chamber electrodes in the apparatus of FIG. 1 for normal, and adverse reaction conditions.

FIG. 4 is a schematic diagram of apparatus embodying the invention for detecting the presence of analytes using optical sensing.

### DETAILED DESCRIPTION OF PREFERRED EMBODIMENTS

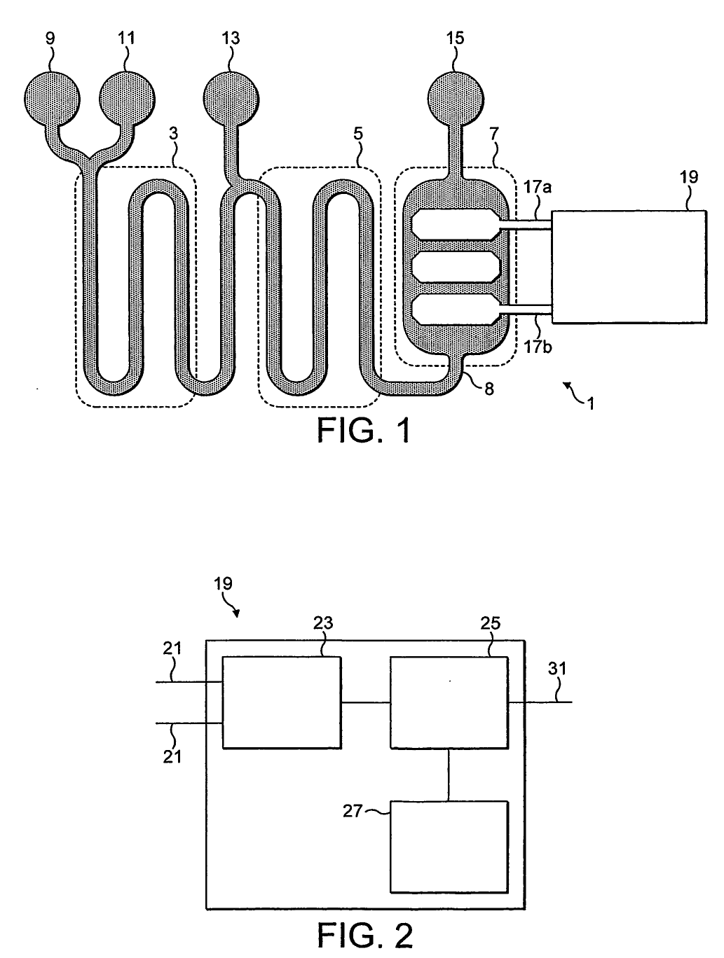

FIG. 1 is a schematic diagram of a microfluidic electrochemical reaction apparatus embodying the invention. The apparatus 1 comprises a first mixing channel 3, second mixing channel 5, and reaction chamber 7. The first mixing channel 3, second mixing channel 5, and reaction chamber 7 are connected so that fluid may pass, in turn, through the first mixing channel 3, through the second mixing channel 5, and into the reaction chamber 7 via chamber inlet 8. The up-stream portion of the first mixing channel 3 is connected to a substrate inlet 9, and an enzyme inlet 11 which supply the first mixing channel 3 respectively with substrate and enzyme. The up-stream portion of the second mixing channel 5 is connected to a mediator inlet 13 which supplies mediator to the second mixing channel 5. The reaction chamber 7 is connected to a waste outlet 15 which allows fluid to pass out of the reaction chamber 7.

The present invention has applications to electrochemical reaction chambers having dimensions in the micrometer scale. One exemplary use of a reaction chamber embodying the present invention is as an analytical component on a miniature bio-chip.

The substrate comprises molecules which may be electrochemically reacted with an enzyme in the reaction chamber 7. The substrate may comprise, for example, any one of a large array of compounds including drugs, pesticides and environmental pollutants, or any other desired compound. The enzyme may be any metabolising enzyme suitable for detoxifying the compound forming the substrate. Examples of such enzymes include proteins from the cytochrome P450 and flavin mono-oxygenase families. The mediator acts as a medium through which electrons may be transported, and may be provided by any suitable electrically conductive fluid. The purpose of the mediator is to allow electrons to be transferred from an electrode 17, located inside the reaction chamber 7, to the enzyme, so that an electrochemical reaction between the enzyme and the substrate may be induced. The substrate, enzyme, and mediator are all provided in a fluid form so that they may flow along the mixing channels 3, 5 and into the reaction chamber 7.

In use, substrate is continually supplied to the first mixing channel 3 through substrate inlet 9 at a first predetermined flow rate, and enzyme is continually supplied to the first mixing channel 3 through enzyme inlet 11 at a second predetermined flow rate. The substrate and enzyme are combined in the first mixing channel 3, for example, by diffuse mixing. The resulting substrate/enzyme mixture flows along the first mixing channel 3 to the second mixing channel 5. No reaction occurs between the substrate and enzyme in the first mixing channel 3 because no electrons are available to induce a reaction.

Mediator is continually supplied to the second mixing channel 5 through mediator inlet 13 at a third predetermined flow rate. Mediator is combined with the substrate/enzyme mixture in the second mixing channel 5, and the resulting substrate/enzyme/mediator mixture, hereinafter referred to as reagent mixture, flows through the second mixing channel 5 to the reaction chamber 7 via chamber inlet 8. The proportions of substrate, enzyme, and mediator in the reagent mixture entering the reaction chamber 7 are determined by the relative magnitudes of the first, second, and third flow rates, which may be adjusted to obtain a desired reagent mixture consistency. Reagent mixture is electrochemically reacted within the reaction chamber 7, and any unreacted reagent mixture, and reaction products are expelled through the waste outlet 15.

The reaction chamber 7 comprises two or more electrodes 17 which are located so that, in use, at least a portion of each electrode 17 is in electrical contact with the reagent mixture contained in the reaction chamber 7. The electrodes 17 are arranged to apply a predetermined voltage across part of the region within the reaction chamber 7 through which reagent mixture passes, in use. The electrodes 17 are connected to a circuit arranged so that a first electrode, 17a for example, has a positive polarity, and a second electrode, 17b for example, has a negative polarity, thereby creating an electric field in the region between the electrodes 17. Electric fields may also be created by several pairs of electrodes 17. When the voltage applied across the electrodes 17 is larger than the redox potential of any of the reagents in the reagent mixture, electrons are caused to flow between the electrodes 17 in the form of an electric current through the mediator. Some of the electrons are transported from the electrode to enzyme molecules through the mediator, and an electrochemical reaction is induced between the enzyme and the substrate.

The electric current flowing between the electrodes 17 may be measured by any suitable current measuring device connected to the electrodes 17. In the preferred embodiment, the electrodes 17 are coupled to a detection circuit 19 arranged to detect and measure the current flow between the electrodes 17. FIG. 2 is a schematic diagram of the detection circuit. The detection circuit 19 comprises inputs 21, a current detector 23, a comparator 25, a memory 27, and an output 31. The detection circuit 19 may be coupled to the electrodes 17 of the reaction chamber 7 via inputs 21 which receive current flowing between the electrodes 17. The inputs 21 are coupled to the current detector 23 which is arranged to detect and measure the current received by the inputs 21, and to generate a signal representative of the size of the current. The signal generated by the current detector 23 is received by the comparator 25 which is arranged to compare the measured current to a predetermined range of values defined by a signal received by the comparator 25 from the memory 27. The memory 27 is arranged to store one or more predetermined ranges, for example, for a steady state current or for a maximum current. The comparator 25 is further arranged to generate a signal indicating whether the measured current lies inside, or outside a selected range of values stored in the memory 27. The signal generated by the comparator 25 is output from the detection circuit 19 via output 31. When the detection circuit 19 is coupled to the electrodes 17, The output 31 provides an indication of whether the electrode current lies inside or outside a particular predetermined range.

In the preferred embodiment, the electrodes 17 provided to induce the electrochemical reaction, and the electrodes 17 provided to measure the current flow through the reagent mixture are the same electrodes 17. In this embodiment, the electrodes 17 perform a dual function, and the components required to work the invention are advantageously provided by existing components. Alternatively, separate pairs of electrodes 17 may be provided for each individual function.

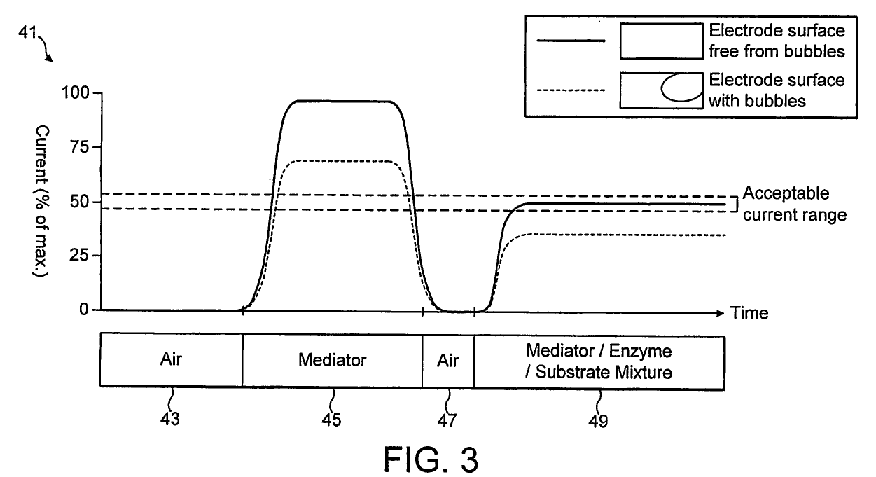

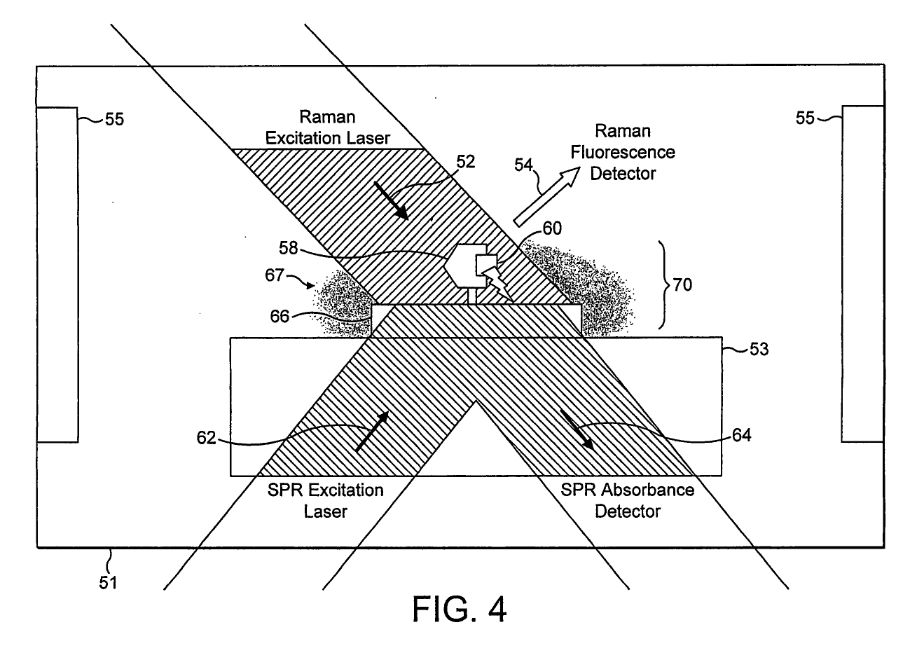

FIG. 3 is a graph showing the time variation of the current flowing between the electrodes 17 during use of the apparatus 1. Initially, the first mixing channel 3, second mixing channel 5, and reaction chamber 7 are filled with air. Since air is electrically insulating, if the voltage applied across the electrodes 17 is below a particular threshold, then no current will flow between the electrodes 17. From time zero, mediator is continually introduced into the second mixing channel 5, which then flows along the second mixing channel 5 towards the reaction chamber 7, displacing air from the second mixing channel 5. During a first time period 43, mediator has not yet reached the reaction chamber 7, and during this time, the electrode current is zero because the reaction chamber is filled with air.

Following the first time period 43, mediator flowing along the second mixing channel 5 arrives at the reaction chamber 7, and subsequently fills the reaction chamber 7. Since the mediator is electrically conductive, the presence of mediator within the reaction chamber 7 allows current to flow between the electrodes 17. During the time the mediator is gradually filling the reaction chamber 7, the electrode current rises from a zero value to a predictable maximum value, which is dependant on the electrical conductivity of the mediator and other factors. During a second time period 45, immediately following the first time period 43, the reaction chamber 7 is filled with mediator, and the electrode current maintains the maximum value.

From time zero, substrate and enzyme are continually introduced into the first mixing channel 3, which then flows along the first mixing channel 3 towards the reaction chamber 7, displacing air from the first mixing channel 3. During the first time period 43 at least, the air displaced from the first mixing channel 3 forms one or more air pockets between the substrate/enzyme mixture flowing along the first mixing channel 3, and the mediator flowing along the second mixing channel 5. As the substrate/enzyme mixture, and mediator flow along the mixing channels 3, 5, the air pockets are transported within the fluid flow to the reaction chamber 7. When the air pockets arrive at the reaction chamber 7, the mediator which previously filled the reaction chamber 7 during the second time period 45 is displaced, and gradually replaced, by air forming the air pockets. During the time air is gradually filling the reaction chamber 7, the electrode current decreases from the maximum value when the reaction chamber is filled with mediator, to a zero value when the reaction chamber is filled with air. During a third time period 47, immediately following the second time period 45, the reaction chamber 7 is filled with air, and the electrode current is maintained at a zero value.

Since substrate, enzyme, and mediator are being continuously introduced into the mixing channels 3, 5, after a particular time, the substrate/enzyme mixture flowing along the first mixing channel 3 will eventually meet and combine with the mediator flowing along the second mixing channel 5 to form a mediator/enzyme/substrate mixture in the second mixing channel 5. It can be seen that this reagent mixture first begins to form upstream from, and adjacent to the air pockets. When the reagent mixture upstream from, and adjacent to the air pockets arrives at, and begins to fill the reaction chamber 7, the electrode current increases from a zero value, up to a particular value. This value depends on the electrical conductivity of the reagent mixture, which in turn, is dependant on the consistency of the mixture. During a forth time period 49, immediately following the third time period 47, the reaction chamber 7 is filled with reagent mixture, and the electrode current maintains a steady state value. At subsequent times, reagent mixture flows continuously through the reaction chamber 7, and the electrode current is maintained at an approximately constant steady state value.

It can be seen that the variation in the electrode current during the first 43, second 45, and third 47 time periods is caused by the presence of air within the apparatus 1, and also the presence of substrate, enzyme, and mediator which are not fully mixed. This variation may be viewed as transient variation in the electrode current. During the forth time period 49 however, the conditions within the apparatus 1 have reached a steady state, and it is during this time period that the electrochemical reaction is initiated. It is important that sufficient time is allowed for the transient conditions to pass, and for the steady state condition to be maintained. Once the acceptable steady state electrode current has been maintained for at least a predetermined time, the voltage applied across the electrodes 17 may be controlled in order to induce an electrochemical reaction. The precise timing of the sequence described above may be controlled by altering the geometry of the apparatus 1.

The steady state electrode current of the forth time period 49 is lower than the maximum electrode current of the second time period 45 because the presence of substrate and enzyme in the reaction chamber 7 lowers the electrical conductivity of the reagent mixture. When an electrochemical reaction is induced, the consumption of electrons by the reaction results in a further reduction in electrode current. In the preferred embodiment, the steady state electrode current is approximately 50% of the maximum electrode current. The steady state current may fluctuate around an average value, but under normal reaction conditions, remains within a predetermined tolerance range.

The steady state electrode current depends on factors including the dimensions of the electrodes 17, the voltage applied across the electrodes 17, and the concentrations of substrate, enzyme, and mediator in the reagent mixture. If the value of each of these factors is determined, then the steady state electrode current is also determined and predictable. It is the predictability of the steady state current, that allows adverse reaction conditions to be detected when the steady state current does not correspond to the predicted current.

It is important that during an electrochemical reaction, the conditions within the reaction chamber 7 are correct, otherwise the reaction process may be affected, and any analysis carried out relating to the reaction may give erroneous results. Some factors that may affect a reaction include the concentrations of substrate, enzyme, and mediator in the reagent mixture, and the surface dimensions of the electrodes 17. Other factors include the electrode 17 spacing, and the voltage applied across the electrodes 17. Another way that reaction conditions may be affected is by the presence of one or more bubble within the apparatus 1.

Since the apparatus 1 is initially filled with air, there is a risk that an air bubble could be trapped within the fluid flowing through the apparatus 1. In one case, a bubble may become trapped in one of the inlets 9, 11, 13, restricting the flow rate of substrate, enzyme, or mediator, and thereby altering the constitution of the reaction mixture. In another case, a bubble may become trapped in one of the mixing channels 3, 5, thereby affecting the mixing of the constituents resulting in non-uniform mixture consistency. A bubble trapped in a mixing channel 3, 5, or any other blockage, may also affect the flow within the apparatus 1, or even prevent flow completely. In yet a further case, a bubble may become trapped inside the reaction chamber 7, and locate on the surface of one or more of the electrodes 17. In this case, the effective surface area of the electrode 17 is reduced, resulting in an increase in electrical resistance across the electrodes 17, and a reduction in electrode current. The reaction conditions may also be affected even if a bubble trapped inside the reaction chamber 7 is not located on the surface of an electrode 17.

The graph shown as a dotted line in FIG. 3 shows the time variation of the electrode current in the case when a bubble is trapped inside the reaction chamber 7, and located on a surface of one of the electrodes 17. During the second 45 and forth 49 time periods, the presence of a bubble on the electrode 17 increases the electrical resistance between the electrodes 17, and causes a reduction in electrode current relative to the case when no bubble is present. The presence of the bubble causes the electrode current to lie outside the range in which the current would be expected to lie if the conditions in the apparatus 1 were normal.

According to the invention, a deviation of the steady state electrode current from the expected value provides an indication that the reaction conditions within the apparatus 1 are adverse. Conversely, an electrode current which conforms to an expected value provides an indication that reaction conditions are normal. Accordingly, any analysis of a reaction may be accepted or rejected according to the output signal generated by the detection circuit 19, which indicates whether the electrode current lies inside, or outside an expected range of values. In one embodiment, the detection circuit 19 generates a signal indicating normal reaction conditions only if the steady state electrode current lies within the predetermined range of values for a predetermined time. If the electrode current falls outside the predetermined range during this time, then a signal is generated to indicate adverse reaction conditions. In this way, it can be seen that the electrodes 17 act as a sensor to enable detection of adverse reaction conditions.

In one embodiment, the value of the maximum electrode current during the second time period 45 is also monitored. In this case, during the second time period 45, the electrode current is measured by the detection circuit 19, and compared to the expected maximum electrode current. If the electrode current lies outside a predetermined range of values, then the detection circuit 19 generates a signal to indicate adverse condition present within the apparatus 1. In this way, if the detection circuit 19 determines during the second time period 45 that conditions within the apparatus 1 are adverse, then the process may be terminated early, saving time, and volume of substrate, enzyme, and mediator used.

It is understood that a deviation of electrode current from the expected value is indicative of adverse reaction conditions which may be caused by any number of factors, of which the presence of a bubble within the apparatus is merely one example. A change in concentrations of substrate, enzyme, or mediator, for example, may also affect the reaction conditions. If the concentration of mediator is higher than normal, then the electrical conductivity of the reagent mixture is higher than normal. Accordingly, the electrode current is higher than would be expected if the mediator concentration were normal. If the mediator concentration deviates sufficiently from the desired concentration, then the steady state electrode current will lie outside the expected range. In a further example, an incorrect voltage applied across the electrodes 17 will cause a deviation in electrode current which may then be detected.

It will be appreciated by the skilled person that the invention is applicable to both static and dynamic electrochemical reaction chambers. In the case of static electrochemical reaction chambers, fluid flow may be discontinuous, for example if a batch process is employed, or there may be no flow of fluid at all. In this case, the presence of bubbles in the reaction chamber 7 causes a characteristic decrease in electrode current over time, indicating adverse reaction conditions. In the case of a dynamic electrochemical chamber, where fluid flow through the reaction chamber 7 is continuous, bubbles passing through the reaction chamber 7 cause brief transient reductions in the electrode current, which may be continually monitored.

A further embodiment of the present invention will now be described in which the conditions within a chamber used to detect the presence of analytes are monitored. In particular, this embodiment is combined with the technique of Surface Enhanced Raman Spectroscopy (SERS) in synergy with Surface Plasmon Resonance (SPR).

Raman Spectroscopy is a well known technique for detecting the presence of analyte molecules. When light is incident on a molecule, most of the photons are elastically scattered. However, a small fraction of the photons are ineleastically scattered as energy is transferred between the photons and the molecule, causing a change in wavelength of the scattered photons. The energy difference between the incident photons and the Raman scattered photons is equal to the energy difference between the vibrational, rotational or electronic energy states of the molecule, giving rise to scattered photons at quantised energy values. The change in frequency of Raman scattered photons may be measured to determine a Raman energy spectrum that is characteristic of the molecule.

The Raman effect is very weak, and a technique known as Surface Enhanced Raman Spectroscopy (SERS) is known to enhance the effect. With SERS, Raman scattering from a compound or ion occurs within a few tens of nanometres of a metal surface resulting in an enhancement of Raman scattering by several orders of magnitude. The SERS effect is essentially caused by an energy transfer between the molecules and an electromagnetic field near the surface of a metal caused by electrons in the metal. In effect, electrons in the metal layer 6 supply energy to the molecule thereby enhancing the Raman effect.

A different technique for measuring the presence of molecules is known as surface plasmon resonance (SPR). An excitation laser beam of plane polarised light is arranged so that it impinges on a metal layer close to the critical angle which is determined by the refractive index of the metal. The electric vector of the excitation laser beam induces a dipole in the surface of the metal layer. The restoring forces from the positive polarisation charge result in an oscillating evanescent electromagnetic field at a resonance frequency of the excitation. In the Rayleigh limit, this resonance is determined mainly by the density of free electrons at the surface of the metal layer (the ‘plasmons’) determining the so-called ‘plasma wavelength’, as well as the dielectric constants of the metal and its environment.

Molecules in an analyte absorbed on or in close proximity to the surface of the layer experience an exceptionally large electromagnetic field in which vibrational modes normal to the surface are most strongly enhanced. This effect enables through-space energy transfer between the plasmons in the metal layer and the molecules near the surface. The energy transfer results in a change in the effective refractive index of the layer causing a change in the critical angle and hence a change in the intensity of refracted light. The change in intensity of scattered photons may then be measured using conventional spectroscopic detectors.

It has been found that The SERS effect for detecting the presence of molecules is enhanced by use of an additional incident laser source, which is preferably also used for SPR detection. The two effects behave synergistically, selectively enhancing the interaction between the surface plasmons and the analyte molecules. Effectively, the second laser is used to pump energy into the excitation produced by the first laser. By varying parameters such as the wavelength of the SPR excitation laser, or the composition and thickness of the metal layer, the SPR effect can be selectively optimised to maximise the SERS signal from a particular analyte molecule. The technique of combining SERS and SPR is described in British patent application 0318356.3.

In an embodiment, a chamber, container or housing 51 of any suitable size is provided for detecting analytes such as protein molecules using the combined SERS/SPR technique described above. The chamber 51 is transparent to allow laser beams 52, 62 to pass into the chamber 51. Positioned within the interior of the chamber is a metal surface 66 for use in the SERS and SPR technique. The metal surface 66 may, for example, be laid upon a substrate 53 located on the base of the chamber 51. Also contained within the chamber 51 are two or more electrodes 55 for detecting whether conditions within the chamber 51 are adverse. The electrodes 55 are arranged so that the region in between the electrodes 55 includes at least part of an analysis region in which analytes to be detected may be present or in which detection of analytes occurs such as close to the metal surface 66 or anywhere else inside the chamber 51. For example, in one embodiment there are two electrodes 55 which are positioned on opposing walls of the chamber 51 so that the region adjacent to the metal surface 66 lies between the electrodes 55 so that adverse conditions in this particular location may be monitored. In another embodiment, the electrodes 55 are arranged so that all or most of the internal volume of the chamber 51 lies between the electrodes 55 so that adverse conditions anywhere inside the chamber 51 may be monitored. The electrodes 55 are further arranged so that they may be connected to a detection circuit (not shown) for detecting the size of any current flowing between the electrodes.

A gas or liquid mixture, possibly containing an analyte to be detected is fed into the chamber 51 via an inlet (not shown). A first laser source, a SERS excitation laser beam 52, is arranged to be incident on a receptor molecule 60, typically an antibody which is bound to a reporter molecule 58 at the electrically conductive metal surface 66. The analyte mixture passes over the metal surface 66 so that an analyte molecule, if present, comes into contact with and binds to the receptor molecule 60. When the analyte molecule binds to the receptor molecule 60, the reporter molecule 58 is displaced and comes close to the surface 66, thereby showing an enhancement in the SERS scattering. In know fashion, SERS scattering occurs and the scattered radiation 54 is detected by any suitable sensor (not shown). At the same time, a second laser source, a SPR laser beam 62, is incident on the metal surface 66. The second laser beam 62 couples with surface plasmons, which in turn generate an electromagnetic field, which couples with vibrational energy states of the molecule to be analysed. The intensity of the refracted light 64 is detected by any suitable sensor (not shown).

During the analyte detection process, a predetermined voltage is applied across the electrodes 55 which induces electric current to flow between the electrodes 55 through the analyte mixture. The size of the electric current may be measured by any suitable current measuring device connected to the electrodes such as the detection circuit shown in FIG. 2. As described in greater detail above, if the measured electric current falls outside a predetermined range, then this provides an indication that the conditions within the chamber 51 are adverse, for example because of the presence of a bubble.

It can be seen that the electrodes 55 need not perform a dual function. For example, in this embodiment, the electrodes 55 are provided only for the purpose of detecting whether conditions are adverse and not for inducing a reaction as with the previous embodiment. However, in an alternative embodiment, one of the electrodes 55 may function as the metal surface 66 in the combined SERS and SPR detection method in addition to providing a means to detect current flow.

In the embodiments described above, it can be seen that the present invention has use in a wide variety of applications. In general, the present invention may be employed in any application where it is necessary to detect adverse conditions when performing chemical or biological analysis, caused for example by the presence of air bubbles, or by an incorrect constitution of mixtures used in the analysis.

Any of the techniques described above, and other techniques may be used in combination. For example, in one embodiment, an electrochemical chamber is used to perform electrochemical reactions with electrodes being provided to induce the reaction. The molecules involved in the reaction such as the reaction products may then be detected using SERS, SPR or combined SERS/SPR. The conditions within the chamber may be monitored both during the reaction and during detection of analytes using a pair of electrodes as described above. The electrodes used to induce the reaction may be the same as the electrodes used to monitor the reaction conditions, and the electrodes used to induce the reaction and/or monitor the reaction conditions may provide the metal surface for the SERS/SPR techniques.

1. A microelectrochemical reaction chamber comprising an inlet for allowing passage of electrochemical reaction constituents into the reaction chamber, and at least two electrodes, the electrodes arranged to have, in use, electrical contact with the reaction fluid, the electrodes being connectable to a detection circuit arranged to detect a current flow between the electrodes, and arranged to generate a signal if the current falls outside a predetermined range, thereby indicating adverse reaction conditions.

2. A microelectrochemical reaction chamber according to claim 1 wherein at least two of the electrodes are arranged to apply a voltage across at least a part of the region through which the reaction constituents pass, in use, thereby inducing an electrochemical reaction between the constituents.

3. A microelectrochemical reaction chamber according to claim 2 wherein the electrodes used to induce the electrochemical reaction are the same as the electrodes used to detect a current flow.

4. A microelectrochemical reaction chamber according to claim 1 wherein the chemical reaction constituents form a mixture including a substrate, an enzyme, and a mediator.

5. A microelectrochemical reaction chamber according to claim 4 wherein the substrate comprises a xenobiotic compound.

6. A microelectrochemical reaction chamber according to claim 4 wherein the enzyme comprises a protein from the cytochrome P450 or flavin mono-oxygenase families.

7. A method of determining whether the reactions conditions in a microelectrochemical reaction chamber are correct comprising feeding reaction fluids in turn into a reaction chamber, monitoring the current flow between electrodes in the reaction chamber, determining whether the current flow lies outside a first defined range, and, if the current lies outside the first defined range, determining that the reaction conditions in the chamber are adverse.

8. The method according to claim 7 wherein the step of feeding reaction fluids into the chamber further comprises the steps of feeding mediator into the chamber, and subsequently feeding a substrate and an enzyme into the chamber.

9. The method according to claim 8 wherein the step of feeding mediator into the chamber further comprises the steps of monitoring the current flow between the electrodes when the reaction chamber contains mediator only, determining whether the current flow lies outside a second defined range, and, if the current lies outside the second defined range, determining that the reaction conditions in the chamber are adverse.

10. The method according to claim 7 wherein the step of feeding reaction fluids into the chamber further comprises the step of feeding a mixture of substrate, enzyme, and mediator into the reaction chamber.

11. The method according to claim 7 wherein the step of determining that the reaction conditions in the chamber are adverse further includes the step of determining that a bubble is located within the reaction chamber.

12. The method according to claim 7 wherein the step of determining that the reaction conditions in the chamber are adverse further includes the step of determining that the concentrations of reaction fluids within the reaction chamber are incorrect.

13. The method according to claim 7 wherein the step of determining that the reaction conditions in the chamber are adverse further includes the step of determining that a voltage applied across the electrodes is incorrect.

14. The method according to claim 7 further comprising the step of generating a signal to indicate whether the reaction conditions in the chamber are adverse.

15. The method according to claim 7 wherein the step of feeding reaction fluids into the chamber further comprises the step of feeding each reaction fluid into the chamber at a predetermined flow rate.

16. Apparatus for determining that the reaction conditions for a microelectrochemical reaction are adverse comprising a microelectrochemical reaction chamber and a detection circuit, wherein the microelectrochemical reaction chamber comprises:
an inlet for allowing passage of electrochemical reaction constituents into the reaction chamber; and
at least two electrodes, the electrodes arranged to have, in use, electrical contact with the reaction fluid, the electrodes being connected to the detection circuit;
and wherein the detection circuit comprises:
a current detector arranged to detect and measure a current flow between the electrodes of the reaction chamber;
a comparator for comparing the current to a predetermined range, and arranged to generate a signal for indicating whether the current lies outside the predetermined range, thereby indicating adverse reaction conditions.

17. A chamber for detecting the presence of molecules in an analyte comprising at least two electrodes, the electrodes being arranged to apply, in use, a voltage across at least a part of an analysis region, the electrodes being connectable to a detection circuit arranged to detect a current flow between the electrodes, and arranged to generate a signal if the current falls outside a predetermined range, thereby indicating adverse conditions in the analysis region.

18. The chamber of claim 17 arranged to detect the presence of analytes by optical means.

19. The chamber of claim 18 further comprising an analyte carrier for use in the detection of analytes in which laser radiation from a first source is used to detect the presence of an analyte by Raman scattering, the analyte carrier comprising:
a substrate for supporting the analyte and having optical properties chosen to match the laser radiation from the first radiation source; and
a conducting surface on a portion of the substrate for receipt of the analyte.

20. The chamber of claim 19 in which a laser radiation from a second laser radiation source is used to generate a field to enhance the Raman scattering, and in which the substrate has optical properties chosen to match the second radiation source.

21. The chamber of claim 19 arranged to detect the presence of analytes at the conducting surface.

22. The chamber of claim 19 in which the conducting surface has deposited thereon a reporter dye having a binding molecule for selectively binding to an analyte molecule to be analysed.

23. The chamber of claim 22 in which the reporter dye is arranged so that, in use, the reporter dye is in an analysis region on binding with a molecule to be analysed.

24. The chamber of claim 19 in which the conducting surface comprises one of the electrodes.

25. A microelectrochemical reaction chamber comprising the chamber of claim 17 in which at least two of the electrodes are arranged to apply a voltage across at least a part of the region through which reaction constituents pass, in use, thereby inducing an electrochemical reaction between the constituents.

26. The microelectrochemical reaction chamber of claim 25 in which the electrodes used to induce the electrochemical reaction are the same as the electrodes used to detect a current flow.

27. A method of detecting the presence of a molecule in an analyte in a chamber, the method comprising the steps of:
providing the analyte on an analysis region of a conducting surface;
luminating the analysis region with first laser radiation to cause Raman scattering;
detecting radiation scattered from the analysis region by Raman scattering to detect the presence of the molecule;
simultaneously illuminating the conducting surface with second laser radiation at an angle to the conducting surface to generate a field in the analysis region, wherein the field generated in the analysis region enhances the Raman scattering effect;
monitoring the current flow between electrodes in the chamber;
determining whether the current flow lies outside a predetermined range; and
if the current lies outside the predetermined range, determining that the conditions in the chamber are adverse.

28. The method of claim 27 in which the step of determining that the condition in the chamber are adverse further includes the step of determining that a bubble is located within the chamber.

29. The method of claim 27 in which the step of determining that the condition in the chamber are adverse further includes the step of determining that the constitution of an analyte mixture is incorrect.

30. The method of claim 27 in which the step of determining that the condition in the chamber are adverse further includes the step of determining that a voltage applied across the electrodes is incorrect.
